(19) United States
(12) Patent Application Publication
(10) Pub. No.: US 2025/0083551 A1
(43) Pub. Date: Mar. 13, 2025

(54) CHARGE AND DISCHARGE MANAGEMENT APPARATUS, CHARGE AND DISCHARGE MANAGEMENT METHOD AND PROGRAM

(71) Applicant: NIPPON TELEGRAPH AND TELEPHONE CORPORATION, Tokyo (JP)

(72) Inventors: Toshimitsu TANAKA, Tokyo (JP); Miho IWAMOTO, Tokyo (JP); Masaki KOZAI, Tokyo (JP); Hiroya MINAMI, Tokyo (JP); Toru TANAKA, Tokyo (JP)

(73) Assignee: NIPPON TELEGRAPH AND TELEPHONE CORPORATION, Tokyo (JP)

(21) Appl. No.: 18/562,296

(22) PCT Filed: May 28, 2021
(86) PCT No.: PCT/JP2021/020538

§ 371 Date: Nov. 18, 2023

(51) Int. Cl. B60L 53/63; B60L 53/67

(52) U.S. Cl. CPC B60L 53/63; B60L 53/67; B60L 2260/52; B60L 2260/54; B60L 2260/58

(57) ABSTRACT

Provided is a charging and discharging management device which includes an information acquisition unit which acquires schedule information on movement of a user of an electric vehicle; a power consumption calculation unit which calculates a movement distance of the electric vehicle on the basis of the schedule information, and calculates a necessary electric energy required for moving the electric vehicle from the movement distance; and a charging schedule creation unit which creates a charging schedule for the plurality of electric vehicles so that the total of charging power of the plurality of electric vehicles that are simultaneously charged does not exceed a predetermined threshold value, on the basis of the required electric energy of each electric vehicle calculated by the power consumption calculation unit

### TECHNICAL FIELD

The present invention relates to a charging and discharging control of an EV.

### BACKGROUND ART

In recent years, electric vehicles (EVs) have come to be widely used, and many companies have studied the introduction of EVs. However, since the electric power required for charging is relatively large, the burden of the electric power cost is a problem. In addition, in order to supply the electric power necessary for charging, it is necessary to change a building power reception capacity (power supply equipment) and to add power reception equipment (a transformer, a power reception board, etc.), which results in a problem of a very large cost.

An EV charger consumes much electric energy when there are a plurality of EV chargers. For example, even normal charging (AC) consumes 3 kW to 6 kW per vehicle, and quick charging consumes 10 kW to 100 kW, which is more power consumption than building air conditioning equipment. Therefore, since the power reception capacity is several hundred kW in a normal commercial building, installation of the EV charger is a heavy load in terms of power.

However, when considering the use of EVs on a commercial base, because it is efficient to charge the EVs outside of working times (when the EVs are parked after work ends), it is desirable to install a charger in an office and charge the EVs from the end of the work to the start of the work.

In recent years, although the use of variable renewable energy (VRE) as the charging power of EVs is also thought to have been becoming a trend, since the electric energy to be used is limited for VRE, it is necessary to appropriately determine the charging amount of each EV in accordance with the prediction of power generation and the use of mobility.

In addition, although a storage battery of an EV is expected to be utilized for a virtual power plant (VP)) such as V2X (V2B (peak cut of a building) and V2G (contribution to system stabilization)) that utilizes the storage battery of an EV, in the first place, it is necessary to hold the amount of electricity stored for the EV to use for mobility, and it is necessary to appropriately determine a dischargeable amount.

Although there is a technique disclosed in NPL 1 as a related art, it is difficult to cope with a schedule different from a normal technique (for example, a long-distance business trip) because charging and discharging are predicted on the basis of probability in the technique.

### CITATION LIST

### Non Patent Literature

[NPL 1] H. Kikusato, K. Mori, S. Yoshizawa, Y. Fujimoto, H. Asano, Y. Hayashi, A. Kawashima, S. Inagaki, and T. Suzuki, “Electric Vehicle Charge-Discharge Management for Utilization of Photovoltaic by Coordination between Home and Grid Energy Management Systems,” IEEE Transactions on Smart Grid, 2018. https://ieeexplore.ieee.org/document/8326541

### SUMMARY OF INVENTION

### Technical Problem

As described above, the related art does not take into account the schedule of an EV user, and it is difficult to perform a balanced operation for mobility utilization, VPP utilization, and the capacity of the power facility of the building.

The present invention has been made in view of the above-mentioned point, and an object of the present invention is to provide a technique that enables charging of a plurality of EVs not to exceed the capacity of a power facility on the basis of a schedule of an EV user.

### Solution to Problem

According to the disclosed technique, there is provided a charging and discharging management device including:
an information acquisition unit which acquires schedule information on movement of a user of an electric vehicle; a power consumption calculation unit which calculates a movement distance of the electric vehicle on the basis of the schedule information, and calculates necessary electric energy required for moving the electric vehicle from the movement distance; and
a charging schedule creation unit which creates a charging schedule for a plurality of electric vehicles so that the total of charging power of the plurality of electric vehicles that are simultaneously charged does not exceed a predetermined threshold value, on the basis of the required electric energy of each electric vehicle calculated by the power consumption calculation unit.

### Advantageous Effects of Invention

According to the disclosed technique, it is possible to charge a plurality of EVs without exceeding the capacity of the power facility on the basis of the schedule of the EV user.

### BRIEF DESCRIPTION OF DRAWINGS

FIG. 1 is an overall configuration diagram of a system according to an embodiment of the present invention.

FIG. 2 is a configuration diagram of a charging and discharging management device.

FIG. 3 is a flowchart for explaining an operation of the charging and discharging management device.

FIG. 4 is a diagram showing an example of a charging power schedule for each time.

FIG. 5 is a diagram showing a hardware configuration example of the charging and discharging management device.

### DESCRIPTION OF EMBODIMENTS

Hereinafter, an embodiment of the present invention (the present embodiment) will be described with reference to drawings. The embodiment described below is a mere example and embodiments in which the present invention is implemented are not limited to the following embodiment.

The term “SoC” used in the following description means “state of charge,” which is an index indicating the residual capacity of a storage battery. The “residual capacity/full charge capacity” of the storage battery is calculated, and it is also called a charging rate or a charging state.

Also, an SoH is a state of health, is also called soundness, and represents a ratio of the full charge capacity at the time of deterioration when an initial full charge capacity of the storage battery is 100%.

“VRE” is an abbreviation for “variable renewable energy,” which is renewable energy that varies output such as photovoltaic power generation.

### (Exemplary System Configuration)

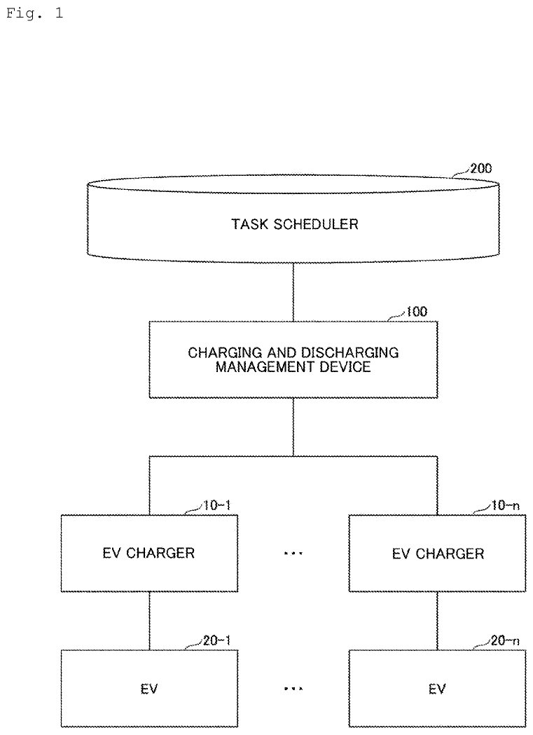

FIG. 1 shows an overall configuration example of a system according to an embodiment of the present invention. As shown in FIG. 1, the system is provided with a task scheduler 200, a charging and discharging management device 100, EV chargers 10-1 to 10-n, and EVs 20-1 to 20-n.

The task scheduler 200 is an information system in which the user inputs and shares action schedules with individuals and organizations such as daily business schedules, conference schedules, and business trip and going-out schedules. In particular, in the present embodiment, information on a schedule for an EV user to go on a business trip or go out using the EV is recorded.

The task scheduler 200 may be a system implemented by a physical computer connected to the charging and discharging management device 100 through a network, or may be a system on a cloud.

The charging and discharging management device 100 creates a charging schedule and performs charging and discharging management for each EV. The details will be described later. The charging and discharging management device 100 may be a system implemented by a physical computer or a system on a cloud.

The EV charger 10 charges the EV 20. The EV charger 10 may include a discharging function, and the EV charger 10 including the discharging function may be called an EV charger/discharger.

Each EV charger 10 is connected to a power distribution facility (power reception facility) of a building, and receives power supply from the power distribution facility. The power distribution facility of the building is supplied with power, for example, from a commercial power supply. Each EV charger 10 may be supplied with electric power, for example, from a renewable energy source such as a photovoltaic power generator installed in a building.

Although the EV 20 may be any vehicle as long as it is an electric vehicle, the EV 20 is assumed to be an electric automobile in this embodiment.

FIG. 1 shows an image in which one EV charger corresponds to one EV, but this is an example. For example, the number of EV chargers may be smaller than the number of EVs. Even in such a case, each EV is charged to meet the demand as much as possible according to the charging schedule.

FIG. 1 shows a case where the EV and the EV charger are provided separately, but this is an example. An on-vehicle charger mounted on the EV may be used. The on-vehicle charger includes, for example, an AC/DC converter, and charges the storage battery by converting AC power into DC. Even in the case of using an on-vehicle charger, the charging and discharging management device 100 can control charging on/off and discharge in the same manner as in the case of an EV charger to be described below.

### (Configuration Example of Charging and Discharging Management Device 100)

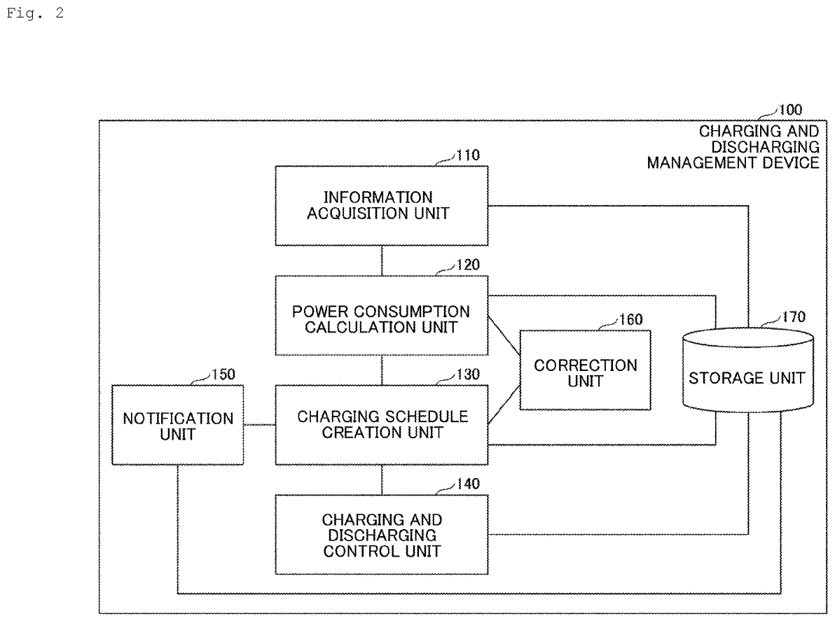

FIG. 2 shows a functional configuration example of the charging and discharging management device 100. As shown in FIG. 2, the charging and discharging management device 100 includes an information acquisition unit 110, a power consumption calculation unit 120, a charging schedule creation unit 130, a charging and discharging control unit 140, a notification unit 150, a correction unit 160, and a storage unit 170.

The information acquisition unit 110 acquires schedule information from a task scheduler 200 as information necessary for creating the charging schedule, and acquires information on an SoC or the like related to a storage battery of each EV from each EV or each EV charger. The acquired information is stored in the data storage unit 170.

The power consumption calculation unit 120 calculates electric energy required for traveling of the EV on the basis of schedule information or the like of a user of the EV.

The charging schedule creation unit 130 creates a charging schedule on the basis of the electric energy of each EV or the like calculated by the power consumption calculation unit 120. The charging and discharging control unit 140 performs charging or discharging by transmitting a control signal to the EV charger 10 on the basis of the charging schedule. The notification unit 150 performs notification to a user.

The correction unit 160 corrects the schedule information, the charging amount, and the like. In addition, correction by the correction unit 160 may not be performed.

### (Basic Operation Example)

A basic operation example of the charging and discharging management device 100 having the above-described structure will be described.

### <Operation Example Related to Charging>

In order to accurately predict a mobility usage amount of the EV, the information acquisition unit 110 extracts a usage time of the EV, a destination, and the like from the task scheduler 200 in which a schedule of an employee or the like using the EV is recorded, and the power consumption calculation unit 120 calculates an electric energy required for movement of the EV.

The charging schedule creation unit 130 calculates a charging amount on the basis of the electric energy required for each EV and the residual capacity of the storage battery calculated by the power consumption calculation unit 120, calculates power used by the EV charger at each time, and creates the charging schedule so that the total of a plurality of EVs to be simultaneously charged does not exceed a threshold (for example, capacity of a power reception facility).

Further, the charging schedule creation unit 130 may cooperate with the demand prediction of the power of the building, and create the charging schedule so that the demand in the whole building does not exceed the contract power.

The charging and discharging control unit 140 charges the EV 20 by transmitting a control signal to the corresponding EV charger 10 according to the created charging schedule.

In the present embodiment, it is assumed that charging is not in time due to insufficient capacity of power reception equipment and VRE to charge a plurality of EVs. When it is detected that charging for a certain user is not in time during the charging schedule creation, the charging schedule creation unit 130 reports it to a notification unit 150, the notification unit 150 transmits an alert to the user, and urges the schedule changes and charging at other charging stations, and the like.

It should be noted that any technique may be used for transmitting the alert. For example, the notification unit 150 may make a phone call or transmit a message to a smart phone or the like owned by the user.

Further, unnecessary use of EV affects power cost and environmental load. Therefore, for example, by referring to the storage unit 170, the notification unit 150 may transmit a message that urges the user to travel by public transportation, when detecting a schedule to a destination where public transportation can be used.

### <Operation Example Related to Discharging>

When using V2X (peak cut (V2B) of a building or use (V2G) for system stabilization) while the EV is waiting in the building, for example, the charging and discharging control unit 140 determines the discharging amount on the basis of the EV usage schedule and charging schedule stored in the storage unit 170, and instructs discharging to an EV charger 10 (having a discharging function) of the corresponding EV 20. As will be described later, the discharging is performed by EV in which a residual capacity of the storage battery is sufficient (EV having a sufficient residual capacity which does not hinder later use).

### <Operation Example Related to Correction>

The schedule information obtained from the task scheduler 200 is not always accurate, and the usage amount of mobility (i.e., the electric energy used by EV) differs depending on the characteristics of the user (difference in operation or the like). In order to compensate these uncertainty, the correction unit 160 corrects the schedule information.

For example, the correction unit 160 corrects the schedule information, using an EV use history (destination, movement amount, electricity cost) of each EV user, thereby increasing the accuracy of electric energy required for mobility.

Specifically, for example, since an action other than the task scheduler registration occurs depending on an EV user, the correction unit 160 compares the EV use history of each user with the schedule information registered in the business scheduler to calculate the occurrence probability of an action outside the schedule registered in the business scheduler and the movement amount.

The correction unit 160 corrects a distance of a route when calculating the electric energy necessary for the movement of the EV to be longer than the actual distance, for example, on the basis of the occurrence probability and the movement amount of the action outside the schedule. That is, a margin of distance is provided. Further, the correction unit 160 may correct the electric energy calculated by the power consumption calculation unit 120 on the basis of the occurrence probability and the movement amount of the action outside the schedule. The correction unit 160 determines a margin on the basis of the occurrence probability and movement amount of action outside the schedule for the charging amount calculated by the charging schedule creation unit 130, notifies the charging schedule creation unit 130 of the margin, and the charging schedule creation unit 130 may use the charging amount to which the margin is added for the charging schedule creation.

When the correction unit 160 refers to the schedule information of the user, and detects that vacation or homework application has already been made, the correction unit 160 may instruct the charging schedule creation unit 130 to lower the priority of charging the EV of the user.

When the registration content of the EV user to the task scheduler 200 and the EV use behavior do not match with each other at a high probability, the correction unit 160 may lower the charging priority and send an alert to the user from the notification unit 150.

### (Example of Detailed Operations)

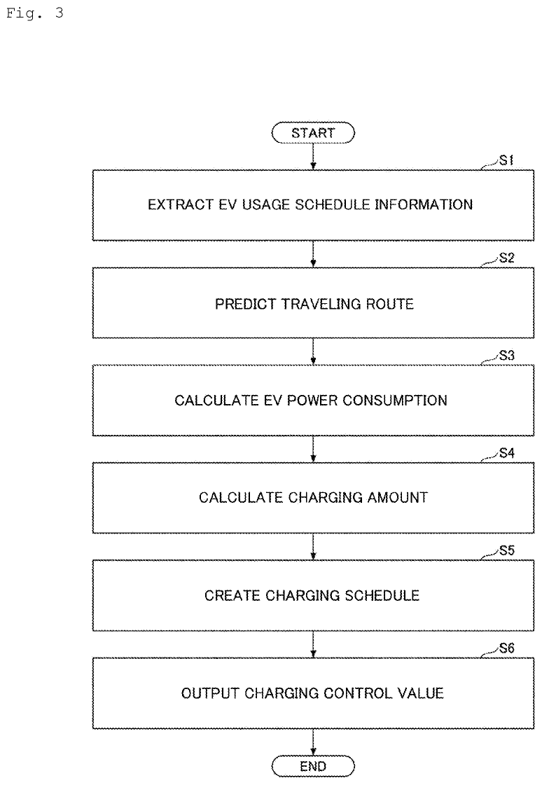

An example of the detailed operation of the charging and discharging management device 100 will be described below with reference to the flowchart of FIG. 3. As a premise of the following operation, it is assumed that schedule information (EV usage schedule information) for each EV user is stored in the task scheduler 200, for example. It is assumed that the storage unit 170 of the charging and discharging management device 100 stores the EV use history (travel route, travel time on the route, etc.) of each user.

First, electric energy Pₜᵣₐᵥ required for movement of the EV for business trip or the like is derived by S1 to S3. Details are as below.

### <S1>

In S1, the information acquisition unit 110 of the charging and discharging management device 100 acquires usage schedule information (schedule information) of the EV of the EV user from business trip information recorded in the task scheduler 200.

The usage schedule information to be acquired includes, for example, a destination of movement by a business trip, a transit point which goes through up to the destination, a departure time, an arrival time, a vehicle type of EV, and the like. The acquired usage schedule information is stored in the storage unit 170. In addition, there may be cases where there is no information of the transit point.

### <S2>

The power consumption calculation unit 120 reads usage schedule information of the EV of the user from the storage unit 170, and calculates (predicts) a travel route of the EV on the basis of the present location, the transit point, and the destination of the EV. Any method may be used for the prediction of the travel route. For example, map data may be acquired from an external map information DB to calculate a route, or a route prediction service may be utilized by accessing a site of an external route prediction application. The information of the route to be predicted may include altitude information.

### <S3>

In S3, the power consumption calculation unit 120 calculates the electric energy Pₜᵣₐᵥ required for the EV to move from the travel route of the EV and power cost data of the EV. The electricity cost data for each vehicle type may be stored in the storage unit 170 in advance, or may be acquired from an external server or the like by designating the vehicle type of the EV.

The electric power cost is a distance traveling at 1 kWh or an electric energy consumed for traveling at 1 km, and the electric energy for moving at the traveling route can be calculated from the distance of the traveling route and the electric power cost.

The calculation of the electric energy by S1 to S3 is performed for each user (each EV) scheduled to be business trip on the day, for example, for each day.

### <S4>

In S4, a charging schedule creation unit 130 calculates, for each EV, an electric energy insufficient for the electric energy required for movement calculated in S3 from the residual capacity of the storage battery of the EV, thereby calculating a charging amount (target charging amount) to be charged to the EV. Specifically, the charging schedule creation unit 130 calculates the charging amount of each EV, using the following data (1) to (4) by a Formula (1). In the following data, “1” and “n” in the P_{bat1}, P_{batn}, etc. are indexes of the EV.
(1) P_{bat1} to P_{batn} A rated capacity of the storage battery of each EV
(2) P_{EV1} to P_{EVn}: Storage battery residual capacity [kWh] of each EV
(3) Pₜᵣₐᵥ1 to Pₜᵣₐᵥₙ: An electric energy [kWh] required for business trip by each EV
(4) P_{chg1} to P_{chgn}: A target charging amount [kWh] required for each EV

$$[ Math . 1 ]$$

$$( \begin{matrix}{P}_{trav 1} \\ {P}_{trav 2} \\ ⋮ \\ {P}_{trav n}\end{matrix} ) - ( \begin{matrix}{P}_{EV 1} \\ {P}_{EV 2} \\ ⋮ \\ {P}_{EV n}\end{matrix} ) = ( \begin{matrix}{P}_{chg 1} \\ {P}_{chg 2} \\ ⋮ \\ {P}_{chg n}\end{matrix} ) \qquad ( 1 )$$

The rated capacity of (1) may be stored in the storage unit 170 in advance or may be acquired from an external server or the like. The residual capacity of (2) may be directly obtained from the EV, or may be calculated from the rated capacity [kWh] of the storage battery and SoC and SoH acquired from the EV. The electric energy of (3) is calculated in S3.

The Formula (1) is a formula for calculating the electric energy insufficient for the required electric energy as the charging amount P_{chg} for each EV. When the residual capacity is larger than the required electric energy, P_{chg} becomes a negative value. As will be described later, this represents the electric energy which can be discharged.

### <S5>

In S5, the charging schedule creation unit 130 creates a charging schedule not to exceed allowable power on the facility side, when charging many EVs on the basis of the charging amount of each EV calculated in S4.

Here, since a function described as F (SOC_{EV}n, SOC_{EVn}′) (t) for each EV is used, first, this function will be described.

SoC_{EVn} represents a residual capacity (charging rate) of each EV (“EVn” is shown here for convenience. The same applies hereinafter) before charging, and SoC_{EVn}=P_{EVn}/P_{batn}. SOC_{EVn}′ represents the residual capacity (charging rate) of each EV after charging, and SoC_{EVn}′=(P_{EVn}+P_{chgn})/P_{batn}.

F (SOC_{EVn}, SOC_{EVn}′) (t) is a function representing the charging power [KW] at the time t from the present (before charging) EV battery residual capacity SoC_{EVn} to the EV charging amount SoC_{EVn}′ after charging, for the EV n (vehicle n). Specifically, the power [KW] used by each of the target chargers is expressed.

Further, P_{chgn} and F (SoC_{EVn}, SOC_{EVn}′) (t) have a relationship represented by the following Formula (2).

$$[ Math . 2 ]$$

$${\int }_{t 1}^{t 2} F ( {SoC}_{BV n} , {SoC}_{EV {n}^{′}} ) ( t ) dt = {P}_{chg n} \qquad ( 2 )$$

The Formula (2) represents that the integration of the charging power from the time t1 of the start of charging to the time t2 of the end of charging is the charging amount (P_{chgn}).

The function F (SoC_{EVn}, SoC_{EVn}′) (t) is predetermined for each vehicle type of EV, and is stored in the storage unit 170. The charging schedule creation unit 150 can refer to F (SoC_{EVn}, SoC_{EVn}′) (t) at an arbitrary time of an arbitrary EV. As for the time length from the charging start t1 to the charging end t2, the time length may be determined to satisfy the Formula (2).

The charging schedule creation unit 130 rearranges the columns P_{chg1} to P_{chgn} of the charging amounts of the respective EVs obtained as a solution by the Formula (1) in the order of the earlier starting time. Each element in the case of rearrangement is defined as P_{chg1}′ to P_{chgn}′. The present (before charging) state of charge (residual capacity of the storage battery) of each EV corresponding to the charging state is defined as P_{EV1}′ to P_{EVn}′.

The charging schedule creation unit 130 creates a charging schedule to charge the charging amount of P_{chg} for each EV so that the charging amount for each time does not exceed the electric energy allowable for charging the EV.

If the electric energy that can be charged does not exceed the electric energy that can be permitted for charging of the EV, the plurality of EV can be simultaneously charged. At this time, the one with the earliest departure time may be preferentially charged according to the arrangement arranged in the order of early departure time.

More specifically, the number of charged vehicles m is determined for each time so that the charging power value of the entire EV that is simultaneously charged is equal to or less than a threshold value Pₗᵢₘ (for example, a power reception capacity of a building or a value obtained by subtracting a power demand of the building from the power reception capacity), and a charging schedule is created to charge the target EV included in the number of charged vehicles.

That is, at each time t, the charging schedule is created so that the total charging powers of m vehicles expressed by the following Formula (3) becomes equal to or less than the Pₗᵢₘ value.

$$[ Math . 3 ]$$

$${\sum }^{m} F ( {SoC}_{EV n} , {SoC}_{EV {n}^{′}} ) ( t ) , \qquad ( 3 )$$

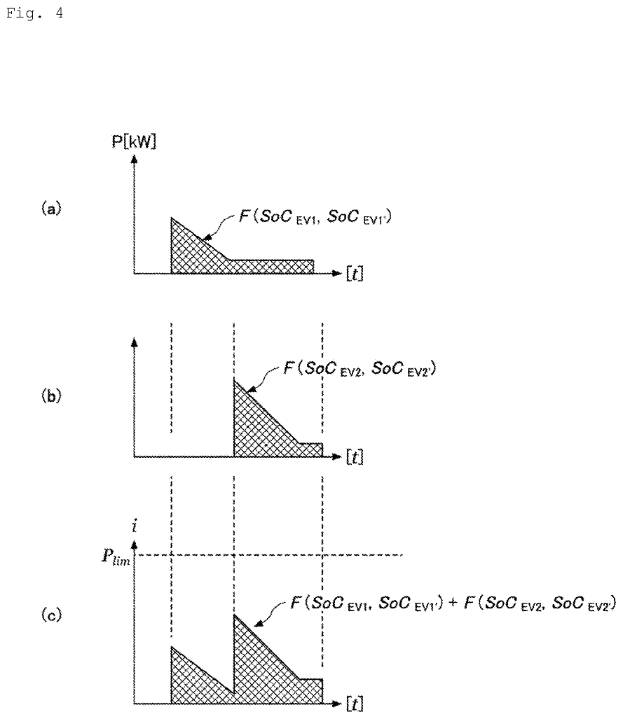

A specific example of charging schedule creation for EV1 and EV2 will be described with reference to FIG. 4. A graph of FIG. 4(a) shows the charging power of the EV1, and an area of a shaded portion shows a charging amount P_{chg1}. A graph of FIG. 4(b) shows the charging power of EV2, and an area of a shaded portion shows a charging amount P_{chg2}

In the example of FIG. 4, as shown in FIG. 4(c), the time when the charging power of the EV1 and the EV2 is high is shifted, by starting the charging of the EV1 earlier than the charging of the EV2, and the charging schedule is set so that the total charging power does not exceed Pₗᵢₘ even if two vehicles are charged at the same time.

The charging schedule creation unit 130 creates, for example, a charging schedule for each day on the basis of the business trip schedule for that day through the above-described process. The charging schedule is created so that the total charging power does not exceed Pₗᵢₘ as described above, and the charging completion time of the EV is before the departure time of the EV.

The charging schedule is represented by, for example, a charging start time and a charging completion time for each EV. The charging schedule creation unit 130 stores the created charging schedule in the storage unit 170.

When the charging schedule creation unit 130 detects that an EV that cannot complete charging occurs before the departure time while creating the charging schedule not to exceed the Pₗᵢₘ, the charging schedule creation unit 130 reports it to the notification unit 150. The notification unit 150 transmits an alert to a user of the EV, and recommends going to another charging stand or use of public transportation.

When creating the charging schedule, the charging schedule creation unit 130 may create a schedule that starts charging with the highest priority to prevent the inability to complete charging before the departure time to EVs used by specific users (executives, etc.), when creating a charging schedule.

### <S6>

In S6, the charging and discharging control unit 140 reads a charging schedule from the storage unit 170, and executes charging by transmitting a charge control signal to the EV charger 10 connected to the EV 20 according to the charging schedule.

The charging schedule creation unit 130 or the charging and discharging control unit 140 reports, for example, completion of charging to a certain EV to the notification unit 150, and the notification unit 150 notifies the user of the EV that the charging is completed.

### <About Usage of Power From Storage Battery of EV>

The charging schedule creation unit 130 determines that EV whose value is 0 or less (may be less than 0) among P_{chg1} to P_{chgn} calculated by the Formula (1) can be used for applications such as virtual power plant (VPP), and stores information indicating that the EV can be used for VPP (information indicating that the EV can be used for discharging) in the storage unit 170. The use of VPP is directed to the amount of P_{chg} which becomes a negative value.

The charging and discharging control unit 140 instructs discharging to the charger 10 (having a discharging function) connected to the EV 20 capable of using VPP, for example, on the basis of an instruction from a power system of a building. For example, discharging is performed by the electric energy of |P_{chg}| of the EV. The discharged power may be used as the power of the building or may be supplied to an electric power company or the like via a power distribution facility.

As described above, the charging and discharging management device 100 performs a control for achieving both mobility utilization and VPP utilization by the control.

### (Hardware Configuration Example)

The charging and discharging management device 100 can be realized, for example, by causing a computer to execute a program. The computer may be a physical computer or a virtual machine on a cloud.

That is, the charging and discharging management device 100 can be realized by executing a program corresponding to the processing performed by the charging and discharging management device 100, using hardware resources such as a CPU and a memory built into the computer. The program can be recorded in a computer-readable recording medium (portable memory, etc.), saved, or distributed. It is also possible to provide the program through a network such as the Internet or email.

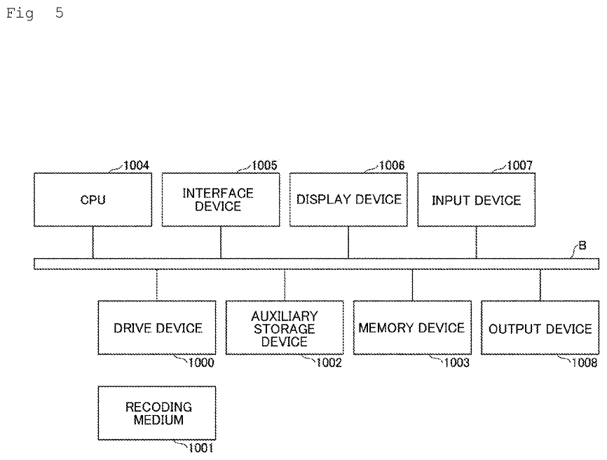

FIG. 5 is a diagram illustrating a hardware configuration example of the computer. The computer of FIG. 5 includes a drive device 1000, an auxiliary storage device 1002, a memory device 1003, a CPU 1004, an interface device 1005, a display device 1006, an input device 1007, an output device 1008, and the like, which are connected to each other through a bus BS.

The program that realizes processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when the start instruction of the program is received. The CPU 1004 realizes a function related to the parameter estimation device 100 according to a program stored in the memory device 1003. The interface device 1005 is used as an interface for connecting to a network. The display device 1006 displays a graphical user interface (GUI) and the like by the program. The input device 1007 is constituted by a keyboard and a mouse, buttons, a touch panel, or the like and is used for inputting various operation instructions. The output device 1008 outputs a calculation result.

### Advantageous Effects of Embodiment

According to the technique according to the present embodiment, charging can be performed with an appropriate charging amount without performing excessive charging equal to or more than the mobility usage amount of EV. Furthermore, a plurality of EVs can be charged with electric power required for business without excessively increasing power facilities on the building side.

Further, since the predicted value of mobility use power of the EV is directly generated from the business schedule data, a causal relationship is clear, and improvement in charging amount accuracy can be expected by utilizing use results.

In addition, by cooperating with the prediction of the VRE, improvement of the re-energy utilization rate of the use power of the EV can be expected. Further, since EV charging amount management according to a request of demand response (DR), VPP or the like can be performed in a stage of schedule creation of a building user, implementation accuracy of EV use (including DR and VPP) for V2X is improved.

### Conclusion of Embodiment

The present specification discloses, at least, a charging and discharging management device, a charging and discharging management method, and a program according to each of the following item 1.

### (Item 1)

A charging and discharging management device including:
an information acquisition unit which acquires schedule information on movement of a user of an electric vehicle;
a power consumption calculation unit which calculates a movement distance of the electric vehicle on the basis of the schedule information, and calculates a necessary electric energy required for moving the electric vehicle from the movement distance; and
a charging schedule creation unit which creates a charging schedule for the plurality of electric vehicles so that the total of charging power of the plurality of electric vehicles that are simultaneously charged does not exceed a predetermined threshold value, on the basis of the required electric energy of each electric vehicle calculated by the power consumption calculation unit.

### (Item 2)

The charging and discharging management device according to item 1,
in which the charging schedule creation unit creates the charging schedule so that charging of the electric vehicle is completed before a departure time of the electric vehicle.

### (Item 3)

The charging and discharging management device according to item 1 or 2, further including:
a notification unit which transmits an alert to a user of the electric vehicle that is not able to complete charging before the departure time.

### (Item 4)

The charging and discharging management device according to any one of items 1 to 3, further including:
a correction unit which corrects the charging amount of the electric vehicle of a certain user on the basis of a use history of the electric vehicle of the user.

### (Item 5)

The charging and discharging management device according to any one of items 1 to 4,
in which the charging schedule creation unit determines an electric vehicle in which a charging amount calculated from the required electric energy and a residual capacity of a storage battery becomes a negative value, as an electric vehicle to be discharged.

### (Item 6)

A charging and discharging management method executed by a computer, the method including:
an information acquisition step of acquiring schedule information on movement of a user of an electric vehicle; a power consumption calculation step of calculating a movement distance of the electric vehicle on the basis of the schedule information, and calculating a necessary electric energy required for moving the electric vehicle from the movement distance; and
a charging schedule creation step of creating a charging schedule for the plurality of electric vehicles so that the total of charging power of the plurality of electric vehicles that are simultaneously charged does not exceed a predetermined threshold value, on the basis of the required electric energy of each electric vehicle calculated by the power consumption calculation unit.

### (Item 7)

A program for causing a computer to function as each part in the charging and discharging management device according to any one of items 1 to 5.

Although the embodiment has been described above, the present invention is not limited to the specific embodiment, and various modifications and changes can be made within the scope of the gist of the present invention described in the claims.

### REFERENCE SIGNS LIST

10-1 to 10-n EV charger
20-1 to 20-n EV
100 Charging and discharging management device
110 Information acquisition unit
120 Power consumption calculation unit
130 Charging schedule creation unit
140 Charging and discharging control unit
150 Notification unit
160 Correction unit
170 Storage unit
200 Task scheduler
1000 Drive device
1001 Recording medium
1002 Auxiliary storage device
1003 Memory device
1004 CPU
1005 Interface device
1006 Display device
1007 Input device

1. A charging and discharging management device comprising a processor configured to execute operations comprising:
acquiring schedule information on movement of a user of an electric vehicle;
calculating a movement distance of the electric vehicle on the basis of the schedule information;
calculating necessary electric energy required for moving the electric vehicle from the movement distance; and
creating a charging schedule for a plurality of electric vehicles so that the total of charging power of the plurality of electric vehicles that are simultaneously charged does not exceed a predetermined threshold value, on the basis of the required electric energy of each electric vehicle.

2. The charging and discharging management device according to claim 1,
wherein the creating a charging schedule further comprises creating the charging schedule so that charging of the electric vehicle is completed before a departure time of the electric vehicle.

3. The charging and discharging management device according to claim 1, the processor further configured to execute operations comprising:
transmitting an alert to a user of the electric vehicle that is not able to complete charging before the departure time.

4. The charging and discharging management device according to claim 1, the processor further configured to execute operations comprising:
correcting the charging amount of the electric vehicle of a certain user on the basis of a use history of the electric vehicle of the user.

5. The charging and discharging management device according to claim 1,
wherein the creating a charging schedule further comprises determining an electric vehicle in which a charging amount calculated from the required electric energy and a residual capacity of a storage battery becomes a negative value as an electric vehicle to be discharged.

6. A method for controlling charging and discharging, comprising:
acquiring schedule information on movement of a user of an electric vehicle;
calculating a movement distance of the electric vehicle on the basis of the schedule information, and calculating necessary electric energy required for moving the electric vehicle from the movement distance; and
creating a charging schedule for a plurality of electric vehicles so that the total of charging power of the plurality of electric vehicles that are simultaneously charged does not exceed a predetermined threshold value, on the basis of the required electric energy of each electric vehicle.

7. A computer-readable non-transitory recording medium storing a computer-executable program instructions that when executed by a processor cause a computer system to execute operations comprising:
acquiring schedule information on movement of a user of an electric vehicle;
calculating a movement distance of the electric vehicle on the basis of the schedule information;
calculating necessary electric energy required for moving the electric vehicle from the movement distance; and
creating a charging schedule for a plurality of electric vehicles so that the total of charging power of the plurality of electric vehicles that are simultaneously charged does not exceed a predetermined threshold value, on the basis of the required electric energy of each electric vehicle.

8. The charging and discharging management device according to claim 2, the processor further configured to execute operations comprising:
transmitting an alert to a user of the electric vehicle that is not able to complete charging before the departure time.

9. The charging and discharging management device according to claim 2, the processor further configured to execute operations comprising:
correcting the charging amount of the electric vehicle of a certain user on the basis of a use history of the electric vehicle of the user.

10. The method according to claim 6,
wherein the creating a charging schedule further comprises creating the charging schedule so that charging of the electric vehicle is completed before a departure time of the electric vehicle.

11. The method according to claim 6, further comprising:
transmitting an alert to a user of the electric vehicle that is not able to complete charging before the departure time.

12. The method according to claim 6, further comprising:
correcting the charging amount of the electric vehicle of a certain user on the basis of a use history of the electric vehicle of the user.

13. The method according to claim 6, wherein the creating a charging schedule further comprises determining an electric vehicle in which a charging amount calculated from the required electric energy and a residual capacity of a storage battery becomes a negative value as an electric vehicle to be discharged.

14. The method according to claim 10, further comprising:
transmitting an alert to a user of the electric vehicle that is not able to complete charging before the departure time.

15. The method according to claim 10, further comprising:
correcting the charging amount of the electric vehicle of a certain user on the basis of a use history of the electric vehicle of the user.

16. The computer-readable non-transitory recording medium according to claim 7, wherein the creating a charging schedule further comprises creating the charging schedule so that charging of the electric vehicle is completed before a departure time of the electric vehicle.

17. The computer-readable non-transitory recording medium according to claim 7, the computer-executable program instructions when executed further causing the computer system to execute operations comprising:
transmitting an alert to a user of the electric vehicle that is not able to complete charging before the departure time.

18. The computer-readable non-transitory recording medium according to claim 7, the computer-executable program instructions when executed further causing the computer system to execute operations comprising:
correcting the charging amount of the electric vehicle of a certain user on the basis of a use history of the electric vehicle of the user.

19. The computer-readable non-transitory recording medium according to claim 7, wherein the creating a charging schedule further comprises determining an electric vehicle in which a charging amount calculated from the required electric energy and a residual capacity of a storage battery becomes a negative value as an electric vehicle to be discharged.

20. The computer-readable non-transitory recording medium according to claim 16, the computer-executable program instructions when executed further causing the computer system to execute operations comprising:
transmitting an alert to a user of the electric vehicle that is not able to complete charging before the departure time.
